(19) United States
(12) Patent Application Publication
(10) Pub. No.: US 2011/0078040 A1
(43) Pub. Date: Mar. 31, 2011

(54) Method and process for choosing real estate to purchase requiring a transformative process using a machine

(76) Inventor: Marie Evoline Meese, Poway, CA (US)

(21) Appl. No.: 12/568,827

(22) Filed: Sep. 29, 2009

(51) Int. Cl. G06Q 50/00; G06F 17/30; G06Q 30/00

(52) U.S. Cl. 705/26.7; 707/E17.044; 707/E17.018; 707/E17.017

(57) ABSTRACT

A transformative, machine based process for choosing real estate to purchase which automatically compiles a list of weighted preferences for a plurality of attributes which the user considers important in making a decision to purchase real estate, then assigns a numerical score to be initially assigned for each of such individual preference attributes, and which generates a report which can efficiently be used to decide which property to purchase.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of business methods and more specifically to a process for choosing real estate to purchase requiring a transformative process using a machine.

Many types of decision making systems have been utilized in the past for a variety of purposes. They have been focused on the business user, so have not been designed to allow the individual easy access. Tools that have been available for homebuyers have been limited to checklists (United States Government Housing and Urban Development Home Buying Guide) and guidelines published by real estate companies and cities. While these offer advice, they are limited in the information or usefulness provided. Also, there is a lack of any decision-making structure or mechanism for making a decision in these tools, merely information.

Typically, home buyers use a variety of methods to determine which one of the properties they are considering should be the one they choose to buy. A number of patents exist which assist realtors and other professionals with different aspects of the property buying process, such as assessing the ability of the homebuyer to obtain financing, allowing the buyer to access the realtor's website, or matching business information for a commercial buyer to realtor offerings. However, these inventions do not contain or utilize a mechanism that allows the homebuyer to evaluate for themselves which property to choose, rather than relying on a realtor to help make that decision.

Since people buy houses infrequently, the typical consumer is inexperienced and uncertain of exactly what steps to take in order to make the best decision for their particular situation. Also, because such a decision typically has tremendous personal financial impact, individuals may hesitate unnecessarily, or make an incorrect choice due to an emotional attachment to a property that does not truly meet their needs.

The present invention creates a transformative, machine based system that the individual buyer can use to determine their preferences, and then make their choices based on how well the target properties match their pre-determined preferences. Its use can assist the real estate professional as well.

Relevant Art includes the following U.S. patents:

U.S. Pat. No. 7,454,355 Milman, et.al. describes a method and system for providing real estate information using a computer network, but it does not provide the buyer with information that can assist with the home buying decision.

U.S. Pat. No. 7,440,921 Rieger, et.al. describes a system and method for evaluating real estate transactions by financial institutions, but it does not assist the home buyer with selecting a home.

U.S. Pat. No. 7,386,496 Braum, et. al. describes a system and method for evaluating real estate financing structures, but it does not provide the buyer with information that can assist with the real estate purchase decision.

U.S. Pat. No. 7,333,943 Charuk et.al. describes a method and system for managing real property transactions by brokerages, but it does not help a buyer manage their own transaction.

U.S. Pat. No. 7,106,866 Chin, et.al. describes a system and method for assisting the buying and selling of property, but it does not help the buyer identify their requirements or produce information the buyer can use to assist with the purchase decision.

U.S. Pat. No. 6,178,406 (Jan. 23, 2001) Cheetham, et. al. describes a method for estimating the value of real property, but it does not help a buyer decide what to buy based on other factors besides price.

U.S. Pat. No. 5,680,305 Apgar, et.al. describes a system and method for evaluating real estate for purchase, lease, or use by a business, but not by an individual.

U.S. Pat. No. 6,876,991 Owen, et.al. describes a system, method and computer program product for a collaborative decision platform, but it does not provide templates the buyer can use to collect relevant data during their search.

U.S. Pat. No. 7,401,059 Owen, et.al. describes a system, method and computer program product for a collaborative decision platform but it does not provide templates the buyer can use to collect relevant data during their search.

U.S. Pat. No. 7,478,076 Owen, et.al. describes a decision-making system, method and computer program product, but it does not help the buyer identify their requirements or produce information the buyer can use to assist with the purchase decision.

U.S. Pat. No. 6,944,816 Updegrove, et.al. describes an automated system for performing Kepner Tregoe analysis for spread sheet output, but it does not help the buyer identify their requirements to assist with the purchase decision.

There is presently no effective, rigorous means for evaluating real estate from a buyer's perspective, or for assisting those buyers wishing to transact business on such real estate. Further, the diverse real estate nomenclature, the infrequency of the typical user's transactions relating to real estate, and the wide scope of factors affecting any given real estate transaction, inhibits effective decision making. Unfortunately, a mistake by an individual in such decisions can be costly, can impact satisfaction with the purchase, and in some cases can be catastrophic financially.

The primary object of the invention is to provide a better method for a consumer or investor to decide what particular parcel(s) of real property to purchase. Because of the complexity of this system, it requires a machine or transformative means to implement it. Accordingly, this invention requires an integrated transformative, machine based mechanism to be used for identifying, assigning and calculating the relevant values to various characteristics of the desired property.

A further object of the invention is to provide an easily used numerical score system that each property will be evaluated by, and once properties are located, a transformative, machine based method system is utilized for collecting and inputting the data about each particular property so as to generate a master score that can easily be used for comparison to other properties.

Another object of the invention is to allow more informed decisions to be made when a person or company purchases real property.

Another object of the invention is to allow for a web based application which can be used by multiple persons to analyze and determine what would be the best parcel(s) of real property to purchase for their needs.

A further object of the invention is to help persons or companies decide which factors are important to them when deciding what parcel or parcels of real estate to purchase.

Yet another object of the invention is to assist persons or companies to consider all factors important to them when making purchase decisions.

Still yet another object of the invention is to assist persons or companies to consider factors that they may not be considering, which should be a part of their decision when making purchase decisions.

Another object of the invention is to assist persons or companies in integrating their financial resource limits into real estate purchase decisions.

Another object of the invention is to allow persons or companies to save time when making real estate decisions.

A further object of the invention is to assist persons or companies planning to purchase real estate by helping to establish a common language for decision making for real estate buyers and realtors.

Another object of the invention is to provide an integrated system for identifying and assigning value to various characteristics of the desired property.

A further object of the invention is to provide a numerical score that each property will be evaluated by, and once properties are located, a system is provided for collecting and inputting data about each particular property to generate a master score that can be used for comparison to other properties.

Other objects and advantages of the present invention will become apparent from the following descriptions, taken in connection with the accompanying drawings, wherein, by way of illustration and example, an embodiment of the present invention is disclosed.

This system for evaluating real estate for purchase by an individual consumer will efficiently assist individuals in making real estate decisions in a manner which provides a quantitative evaluation of the important factors to a particular buyer which are associated with a prospective real estate transaction.

The present invention overcomes past problems by providing an integrated transformative, machine based method which allows a prospective real estate investor to:

Identify preferences

Assign value to those preferences

Generate a list of preferences

Locate properties

Compile comments, pictures and scores for each preference, for each property

Creating an overall score for each property

Edit the original list and/or value of preferences

Generate an updated score

Compare scores and comments for each property

A transformative, machine based method is required to efficiently achieve the above goals, because the complexity of trying to create such a comparison report would be impossible unless a transformative, machine based method was used.

### BRIEF SUMMARY OF THE INVENTION

In accordance with a preferred embodiment of the invention, there is disclosed a process for choosing real estate to purchase comprised of: A first input means capable of compiling a list of weighted preferences for a plurality of attributes which the user considers important in making a decision to purchase real estate, a means to assign a numerical score to be initially assigned for each of such individual preference attributes, A first processing transformative mechanism means capable of generating a list of weighted preferences from the first input means, A first export means to export the generated list of weighted preferences from the first input means, A first storage means capable of storing the exported list of weighted preferences from the first input means, A means of locating possible properties which may be desirable, a means to assign a numerical score to be initially assigned for each of the individual preference attributes on each particular property located by the locating means, A second input means capable of compiling a list of numerically scored attributes of the possible properties which have been located by the locating means, A second processing transformative mechanism means capable of assigning a numerical score for each possible property as it fits each attribute which the user considered important when compiling the first list of important attributes by multiplying that numerical score initially assigned for each such individual attribute for each property by the numerical rating assigned to that attribute for a particular preference and then adding the results for each individual attribute for a particular property to generate an overall score for that property, A second export means to export the generated list of numerical scores for each possible property as it fitted each attribute which the user considered important when compiling the first list of important attributes, A second storage means capable of storing the assigned numerical score for each possible property as it fitted each attribute which the user considered important when compiling the first list of important attributes, A third input means capable of editing the list of compiled weighted preferences for a the plurality of attributes which the user considered important when compiling the first list of weighted attributes using the first input means, A third input means capable of compiling a list of attributes of additional possible properties which have been subsequently located by the locating means, A third transformative mechanism processing means capable of assigning an updated numerical score for all possible properties as they fit for each attribute which the user considered important when compiling the first list of important attributes, and A third storage means capable of storing the updated numerical score for all possible properties.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

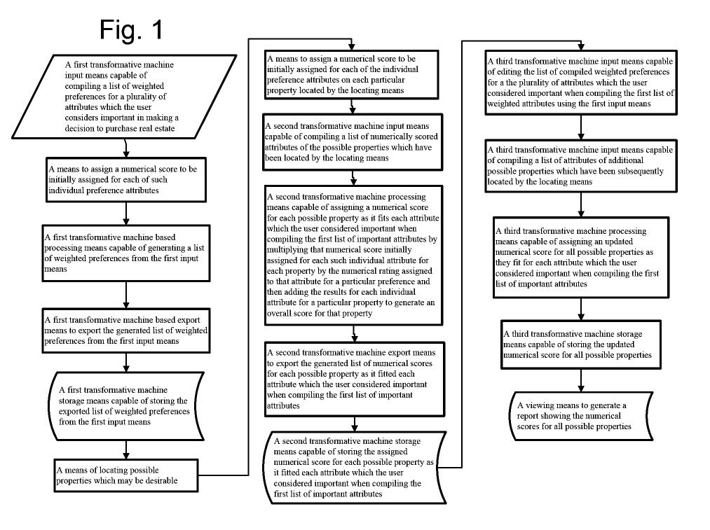

FIG. 1 illustrates in graphic form the invention using a transformative, machine based apparatus, according to the invention, for storing, processing, accessing, updating and reporting results of real estate data processed.

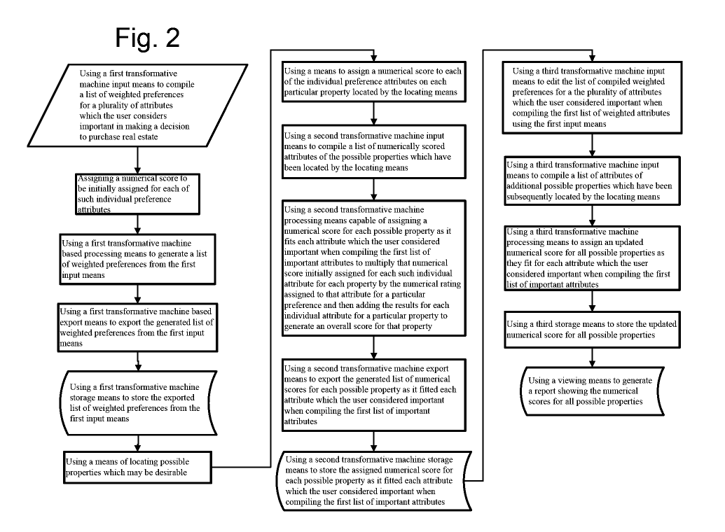

FIG. 2 illustrates in graphic form the process methodology and system, using a transformative, machine based apparatus according to the invention, for storing, processing, accessing, updating and reporting results of real estate data processed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The instant invention is a transformative machine based method or process for choosing real estate from a field of potential candidates comprising a number of steps which transform information that must be, because of the complexity of the system, performed by a computer or other calculating machine which then transforms the steps into the useful result of making it easy to choose the best parcel of real estate for the particular user who is using the invention.

The first step requires a first transformative machine input means capable of compiling a detailed list of weighted preferences for a plurality of attributes which the user considers important in making a decision to purchase real estate. Next a means is used to assign a numerical score to be initially assigned for each of such individual preference attributes. Then a first transformative machine based processing means capable of generating a list of weighted preferences from the first input means is used to generate a list of weighted preferences. Next a first transformative machine based export transformative machine based processing means is used to export the generated list of weighted preferences from the first input means. Then a first transformative machine based storage means capable of storing the exported list of weighted preferences from the first input means is used. The user then uses either a manual or machine based means of locating possible properties which may be desirable. At this point a transformative machine based means is used to assign a numerical score to be initially assigned for each of the individual preference attributes on each particular property located by the locating means. Then a second transformative machine based input means capable of compiling a list of numerically scored attributes of the possible properties which have been located by the locating means is utilized. The second transformative machine based processing means capable of assigning a numerical score for each possible property as it fits each attribute which the user considered important when compiling the first list of important attributes is used for multiplying that numerical score initially assigned for each such individual attribute for each property by the numerical rating assigned to that attribute for a particular preference and then using a transformative machine based adding means the results for each individual attribute for a particular property are used to generate an overall score for that property. A second transformative machine based export means is required to export the generated list of numerical scores for each possible property as it fitted each attribute which the user considered important when compiling the first list of important attributes. A second transformative machine based storage means capable of storing the assiged numerical score for each possible property as it fitted each attribute which the user considered important when compiling the first list of important attributes is also required, as is a third transformative machine based input means capable of editing the list of compiled weighted preferences for a the plurality of attributes which the user considered important when compiling the first list of weighted attributes using the first input means. Also a third transformative machine based input means capable of compiling a list of attributes of additional possible properties which have been subsequently located by the locating means, a third transformative machine based processing means capable of assigning an updated numerical score for all possible properties as they fit for each attribute which the user considered important when compiling the first list of important attributes; and a third transformative machine based storage means capable of storing the updated numerical score for all possible properties is utilized.

In other preferred embodiments, the first, second and third input, processing, export and storage means are accessible directly from the users' computer without requiring any access to any other network. Other preferred embodiments utilize first, second and third input, processing, export and storage means which are accessible online on an intranet or on the world wide web.

In addition, the exported report can be printed on paper or saved in an electronic format.

The possible real properties can be located by the user directly themselves, using a real estate broker or sales person, searching on a computer, or a newspaper, magazine etc.

In another preferred embodiment, additional properties can be added to the input means by a separate screen, or they can be added by appending them to the initial list of possible properties.

In the preferred embodiment, the numerical scores are calculated from 0 to 10, but any numerical value system can be used. Also for the convenience of the user, the initial or subsequent input means provides a means for entering written free-form comments.

The Transformative machine based processing means required for this system does not have to be anchored to a desk. It can also be embodied and made accessible on a hand held input and display device.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A transformative machine based method for choosing real estate to purchase comprising:
a first transformative machine input means capable of compiling a list of weighted preferences for a plurality of attributes which the user considers important in making a decision to purchase real estate;
a means to assign a numerical score to be initially assigned for each of such individual preference attributes;
a first transformative machine based processing means capable of generating a list of weighted preferences from the first input means;
a first transformative machine based export means to export the generated list of weighted preferences from the first input means;
a first transformative machine storage means capable of storing the exported list of weighted preferences from the first input means;
a means of locating possible properties which may be desirable;
a means to assign a numerical score to be initially assigned for each of the individual preference attributes on each particular property located by the locating means;
a second transformative machine input means capable of compiling a list of numerically scored attributes of the possible properties which have been located by the locating means;
a second transformative machine processing means capable of assigning a numerical score for each possible property as it fits each attribute which the user considered important when compiling the first list of important attributes by multiplying that numerical score initially assigned for each such individual attribute for each property by the numerical rating assigned to that attribute for a particular preference and then adding the results for each individual attribute for a particular property to generate an overall score for that property;
a second transformative machine export means to export the generated list of numerical scores for each possible property as it fitted each attribute which the user considered important when compiling the first list of important attributes;
a second transformative machine storage means capable of storing the assigned numerical score for each possible property as it fitted each attribute which the user considered important when compiling the first list of important attributes;
a third transformative machine input means capable of editing the list of compiled weighted preferences for a the plurality of attributes which the user considered important when compiling the first list of weighted attributes using the first input means;
a third transformative machine input means capable of compiling a list of attributes of additional possible properties which have been subsequently located by the locating means;
a third transformative machine processing means capable of assigning an updated numerical score for all possible properties as they fit for each attribute which the user considered important when compiling the first list of important attributes;
a third transformative machine storage means capable of storing the updated numerical score for all possible properties; and
a viewing means to generate a report showing the numerical scores for all possible properties

2. The transformative machine based method for choosing real estate to purchase as claimed in claim 1 wherein the first, second and third transformative machine input, processing, export and storage means are accessible directly from a users' computer means without requiring any access to any other network.

3. The transformative machine based method for choosing real estate to purchase as claimed in claim 1 wherein the first, second and third transformative machine input, processing, export and storage means are accessible online on an intranet.

4. The transformative machine based method for choosing real estate to purchase as claimed in claim 1 wherein the first, second and third transformative machine input, processing, export and storage means are accessible online on the world wide web.

5. The transformative machine based method for choosing real estate to purchase as claimed in claim 1 wherein said additional properties can be added to the input means by a separate screen.

6. The transformative machine based method for choosing real estate to purchase as claimed in claim 1 wherein additional properties can be added to the input means by appending them to the initial list of possible properties.

7. The transformative machine based method for choosing real estate to purchase as claimed in claim 1 wherein numerical scores are calculated from 0 to 10.

8. The transformative machine based method for choosing real estate to purchase as claimed in claim 1 wherein the initial transformative machine input means provides a means for entering written free-form comments.

9. The transformative machine based method for choosing real estate to purchase as claimed in claim 1 wherein the first, second and third input, processing, export and storage means are accessible on a hand held input and display device.

10. A process for choosing real estate to purchase comprising the steps of:
using a first transformative machine input means to compile a list of weighted preferences for a plurality of attributes which the user considers important in making a decision to purchase real estate;
assigning a numerical score to be initially assigned for each of such individual preference attributes;
using a first transformative machine based processing means to generate a list of weighted preferences from the first input means;
using a first transformative machine based export means to export the generated list of weighted preferences from the first input means;
using a first transformative machine storage means to store the exported list of weighted preferences from the first input means;
using a means of locating possible properties which may be desirable;
using a means to assign a numerical score to each of the individual preference attributes on each particular property located by the locating means;
using a second transformative machine input means to compile a list of numerically scored attributes of the possible properties which have been located by the locating means;
using a second transformative machine processing means capable of assigning a numerical score for each possible property as it fits each attribute which the user considered important when compiling the first list of important attributes to multiply that numerical score initially assigned for each such individual attribute for each property by the numerical rating assigned to that attribute for a particular preference and then adding the results for each individual attribute for a particular property to generate an overall score for that property;
using a second transformative machine export means to export the generated list of numerical scores for each possible property as it fitted each attribute which the user considered important when compiling the first list of important attributes;
using a second transformative machine storage means to store the assigned numerical score for each possible property as it fitted each attribute which the user considered important when compiling the first list of important attributes;
using a third transformative machine input means to edit the list of compiled weighted preferences for a the plurality of attributes which the user considered important when compiling the first list of weighted attributes using the first input means;
using a third transformative machine input means to compile a list of attributes of additional possible properties which have been subsequently located by the locating means;
using a third transformative machine processing means to assign an updated numerical score for all possible properties as they fit for each attribute which the user considered important when compiling the first list of important attributes; and
using a third storage means to store the updated numerical score for all possible properties.
using a viewing means to generate a report showing the numerical scores for all possible properties.

11. A process for choosing real estate to purchase as claimed in claim 10 wherein the first, second and third input, processing, export and storage means are accessible directly from the users' computer without requiring any access to any other network.

12. A process for choosing real estate to purchase as claimed in claim 10 wherein the first, second and third input, processing, export and storage means are accessible online on an intranet.

13. A process for choosing real estate to purchase as claimed in claim 10 wherein the first, second and third input, processing, export and storage means are accessible online on the world wide web.

14. A process for choosing real estate to purchase as claimed in claim 10 wherein the possible real properties are located by the user directly themselves, using a real estate broker or sales person, searching on a computer, or a newspaper, magazine etc.

15. A process for choosing real estate to purchase as claimed in claim 10 wherein said additional properties can be added to the input means by a separate screen.

16. A process for choosing real estate to purchase as claimed in claim 10 wherein additional properties can be added to the input means by appending them to the initial list of possible properties.

17. A process for choosing real estate to purchase as claimed in claim 10 wherein numerical scores are calculated from 0 to 10.

18. A process for choosing real estate to purchase as claimed in claim 10 wherein the initial input means provides a means for entering written free-form comments.

19. A process for choosing real estate to purchase as claimed in claim 10 wherein the first, second and third input, processing, export and storage means are accessible on a hand held input and display device.
